(19) United States
(12) Patent Application Publication
(10) Pub. No.: US 2007/0093129 A1
(43) Pub. Date: Apr. 26, 2007

(54) Rail adjustment device

(76) Inventor: Hsueh-Yu Ho, Cingshuei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,045

(22) Filed: Oct. 25, 2005

(51) Int. Cl. H01R 9/05

(52) U.S. Cl. 439/579

(57) ABSTRACT

A rail adjustment device including an adjustment mechanism for adjusting and locating the rail. The adjustment mechanism includes a bar body having a locating section. Multiple pairs of notches are formed on opposite corners of the locating section. By means of swiveling the bar body, a locating member can be engaged in or disengaged from one of the notches. The locating member can be snugly engaged in the notch without swinging. This ensures good quality of the rail in use or operation.

### BACKGROUND OF THE INVENTION

The present invention is related to a rail of a chair, and more particularly to a rail adjustment device.

FIGS. 8 and 9 show a conventional rail adjustment mechanism of a chair. The adjustment mechanism includes a tubular body 7 having a slide channel 71. The tubular body 7 is formed with multiple locating holes 72. A bar member 81 and a cooperative iron plate 82 are mounted on a bracket 8. The bracket 8 is fitted into the slide channel 71 of the tubular body 7. The bar member 81 can be pulled to push a slope 821 of the iron plate 82. At this time, the free end of the iron plate 82 will be lifted to retract a locating member 83 connected with the free end. At this time, the locating member is disengaged from the locating hole 72, permitting the bar member 81 to freely slide within the tubular body 7 for adjusting the position of the rail pad 9.

In order to engage the locating member 83 in the locating hole 72, a tolerance is preserved in the locating hole 72. Therefore, the size of the locating hole 72 is slightly larger than the thickness of the locating member 83. As a result, when engaged, the locating member 83 will be slightly loosened. This affects the quality of the rail.

Moreover, the bar member 81 must precisely cooperate with the iron plate 82 for effectively pushing the slope 821 of the iron plate 82 to drive and totally disengage the locating member 83 from the locating hole 72. Only under such circumstance, the bar member 81 can freely slide within the tubular body 7. The high precision necessitates higher manufacturing cost.

### SUMMARY OF THE INVENTION

It is therefore a primary object of the present invention to provide a rail adjustment device including an adjustment mechanism for adjusting and locating the rail. The adjustment mechanism includes a bar body having a locating section. Multiple pairs of notches are formed on opposite corners of the locating section. By means of swiveling the bar body, a locating member can be engaged in or disengaged from one of the notches. The locating member can be snugly engaged in the notch without swinging. This ensures good quality of the rail in use or operation.

It is a further object of the present invention to provide the above rail adjustment device which achieves the adjustment function by means of simple engagement structures. Therefore, no precise assembly or adaptation is required so that the manufacturing cost is lowered.

According to the above objects, the rail adjustment device of the present invention includes:

an inner tube having a fixed section at one end for fixing the inner tube on a chair, the other end of the inner tube having an insertion section;

an outer tube slidably fitted around the inner tube, one end of the outer tube being expanded to form a connecting section, a window being formed on one side of the outer tube near the connecting section;

an adjustment mechanism disposed in the inner tube and outer tube for adjustably driving the outer tube to reciprocally slide along the inner tube through a certain distance; and

a rail pad, a lower side of the rail pad being connected with the connecting section of the outer tube, an upper side of the rail pad being for a user's hand to rest thereon.

The rail adjustment device is characterized in that the adjustment mechanism includes a fixing member, a resilient member, a bar body, a locating member engageable with the bar body, a driving member, a handle fitted on the driving member for driving the bar body, wherein:

the fixing member is connected in the connecting section of the outer tube, the fixing member having a coupling section connected with a connecting section of one end of the bar body, the resilient member being fitted on the coupling section and two ends of the resilient member being respectively connected with the fixing member and the bar body;

the locating member is inserted in the insertion section of the inner tube, the locating member having an upper stop face and a lower stop face, the locating member being formed with a through hole along an axis of the bar body, whereby the bar body is fitted through the through hole; and

a guide slot is obliquely formed on outer circumference of the connecting section of the bar body, a post being disposed on inner face of the driving member, whereby the post can be inlaid in the guide slot to drive the bar body, the bar body further having a locating section adjacent to the connecting section, multiple pairs of notches being formed on opposite corners of the locating section, each notch having an upper stop face and a lower stop face, the bar body further having a stop section extending from the locating section opposite to the connecting section.

The upper and lower stop faces of the locating member respectively abut against the upper and lower stop faces of the notch of the bar body. Therefore, the locating member can be precisely engaged in the notch.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a sectional view of the adjustment mechanism of the present invention;

FIG. 4 shows the engagement between the locating member and the notch of the locating section of the bar body of the present invention in one state;

FIG. 5 shows the engagement between the locating member and the notch of the locating section of the bar body of the present invention in another state;

FIG. 6 shows the disengagement between the locating member and the notch of the locating section of the bar body of the present invention in one state;

FIG. 7 shows the disengagement between the locating member and the notch of the locating section of the bar body of the present invention in another state;

FIG. 8 is a sectional view of a conventional rail adjustment mechanism of a chair in an engaged state; and

FIG. 9 is a sectional view of the conventional rail adjustment mechanism of a chair in a disengaged state.

### DETAILED DESCRIPTION OF THE PREFERRED EMBODIMENT

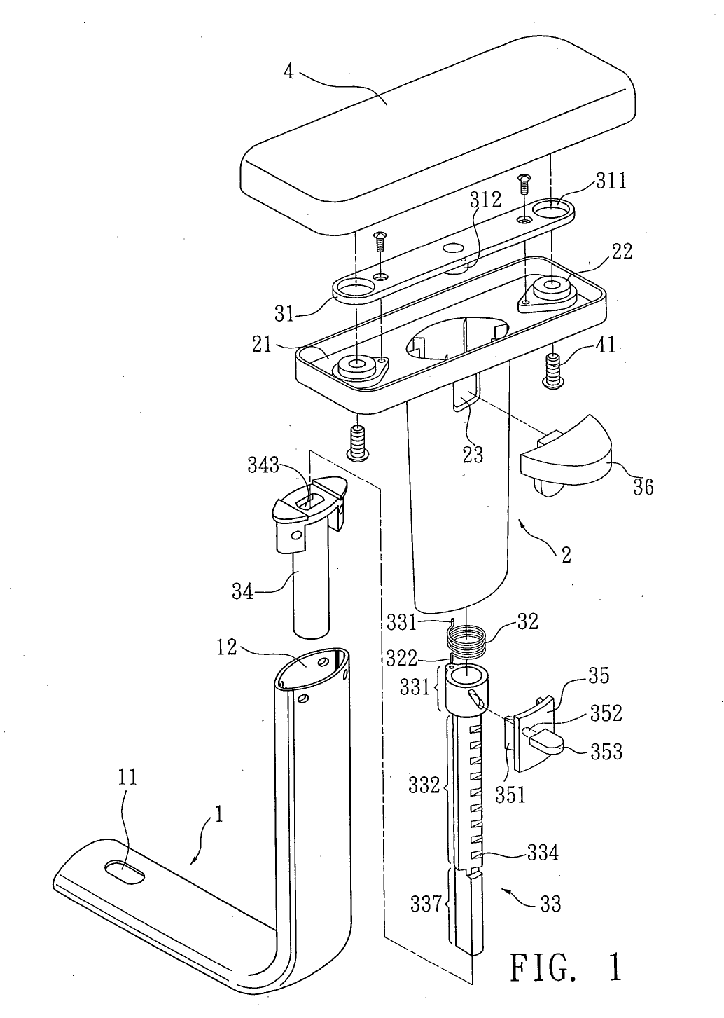

Please refer to FIG. 1. The rail adjustment device of the present invention includes an inner tube 1 having a fixed section 11 at one end for fixing the inner tube 1 on a chair. The other end of the inner tube 1 has an insertion section 12.

The rail adjustment device of the present invention further includes an outer tube 2 slidably fitted around the inner tube 1. One end of the outer tube 2 is expanded to form a connecting section 21 having two wing sections. An upward protruding boss section 22 is disposed in each wing section. A window 23 is formed on one side of the outer tube 2 near the connecting section 21. A linear slide channel 24 is formed on inner wall face of the outer tube 2 beside the window 23.

The rail adjustment device of the present invention further includes an adjustment mechanism 3 including a fixing member 31. The fixing member 31 has two wings each having a through hole 311. A coupling section 312 downward protrudes from the middle of the fixing member 31. The present invention further includes a resilient member 32 which is a torque spring in this embodiment. The resilient member 32 serves to bear radial action force and has an upper connecting end 321 and a lower connecting end 322. The present invention further includes a bar body 33. One end of the bar body 33 has a connecting section 331. A guide slot 332 is obliquely formed on outer circumference of the connecting section 331. The bar body 33 further has a minified locating section 333 immediately under the connecting section 331. Multiple pairs of notches 334 are formed on opposite corners of the locating section 333. Each notch 334 has an upper stop face 335 and a lower stop face 336. In addition, a stop section 337 downward extends from the locating section 333. The. stop section 337 is swiveled about the axis of the bar body 33 by a certain angle. The present invention further includes a locating member 34 having an upper stop face 341 and a lower stop face 342. The locating member 34 is formed with a through hole 343 along the axis of the bar body 33. The bar body 33 is fitted through the through hole 343. The present invention further includes a driving member 35 having a wing section 351. A post 352 is disposed on inner face of the driving member 35. A tongue plate 353 is disposed on outer face of the driving member 35. A handle 36 is fitted on the tongue plate 353.

The present invention further includes a rail pad 4. A lower side of the rail pad 4 is connected with the connecting section 21 of the outer tube 2. A user's hand can rest on an upper side of the rail pad 4.

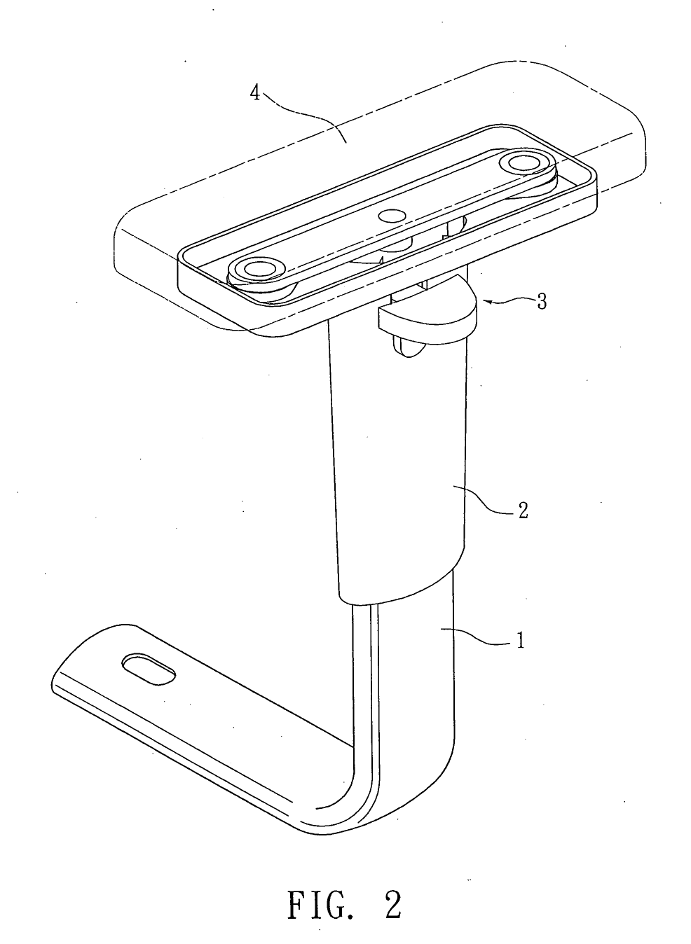

Referring to FIG. 2, when assembled, the locating member 34 of the adjustment mechanism 3 is first inserted in the insertion section 12 of the inner tube 1. The resilient member 32 is fitted on the coupling section 312 of the fixing member 31. Then the connecting section 331 of the bar body is coupled with the coupling section 312 of the fixing member 31. The upper connecting end 321 of the resilient member 32 is fixed with the fixing member 31 and the lower connecting end 322 is fixed with the connecting section 331 of the bar body. The driving member 35 is placed into the outer tube 2 with the tongue plate 353 extending out through the window 23 of the outer tube 2. The wing section 351 of the driving member 35 is slidably attached to the slide channel 24 of the outer tube 2. then the handle 36 is fitted on the tongue plate 353 of the driving member 35 from outer side of the outer tube 2.

Then, the outer tube 2 is fitted around the inner tube 1. Then the stop section 337 of the bar body 33 is aimed at the through hole 343 of the locating member 34 to fit the bar body 33 through the through hole 343 of the locating member 34. After the stop section 337 is totally passed through the through hole 343, the bar body 33 is swiveled by a certain angle, whereby the locating section 333 of the bar body 33 can further pass through the through hole 343 of the locating member 34. When the guide slot 332 of the bar body 33 is nearly aligned with the window 23 of the outer tube 2, the fixing member 31 is swiveled by a certain angle to fit the bosses 22 of the connecting section 21 of the outer tube 2 into the through holes 311 of two wings of the fixing member 31. Accordingly, the post 352 of the driving member 35 can be inlaid in the guide slot 332 of the bar body 33. Finally, the rail pad 4 is locked on the connecting section 21 of the outer tube with locking members.

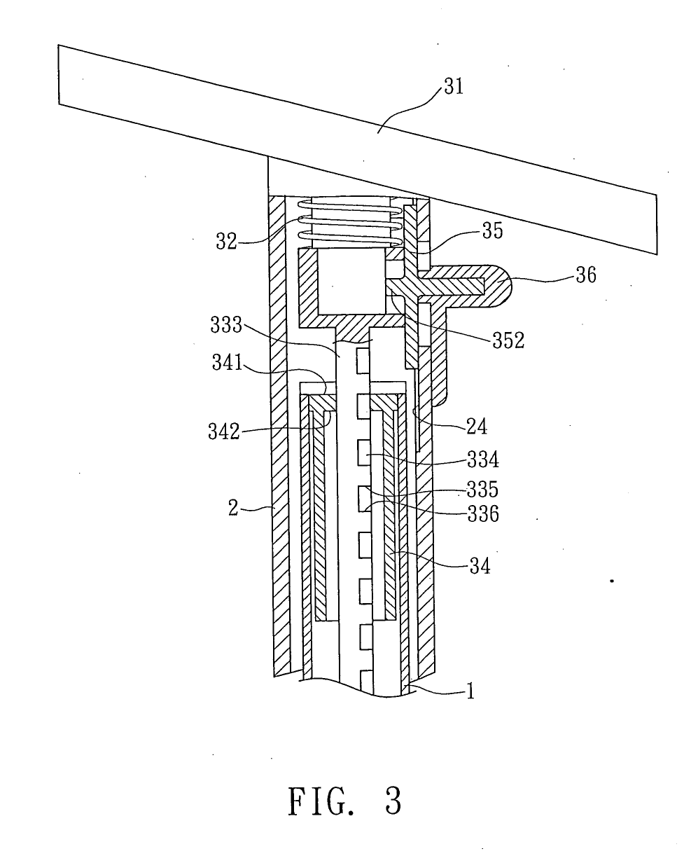

After the fixing member 31 is swiveled by a certain angle relative to the outer tube 2, a torque is applied to the resilient member 32. When the resilient member 32 restores to its home state, the resilient member 32 will exert a torque onto the bar body 33 and swivel the bar body 33, whereby the locating member 34 can be engaged in the notch 334 of the locating section 333 of the bar body 33. Accordingly, the rail can be lifted or lowered and located as shown in FIG. 3.

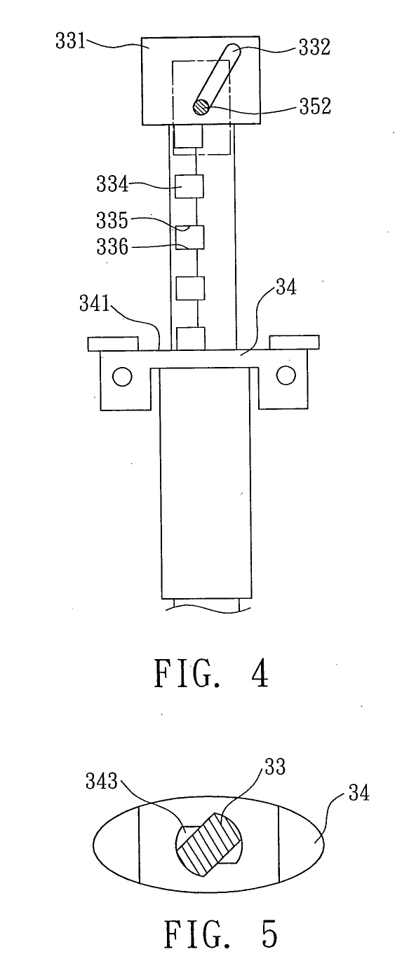

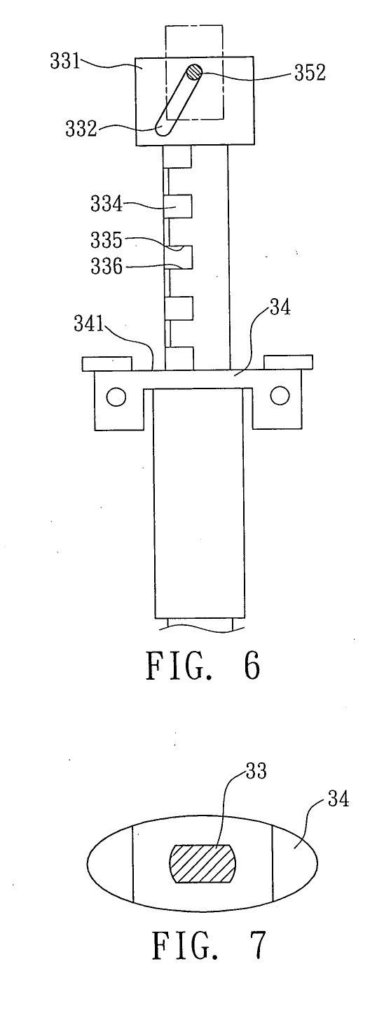

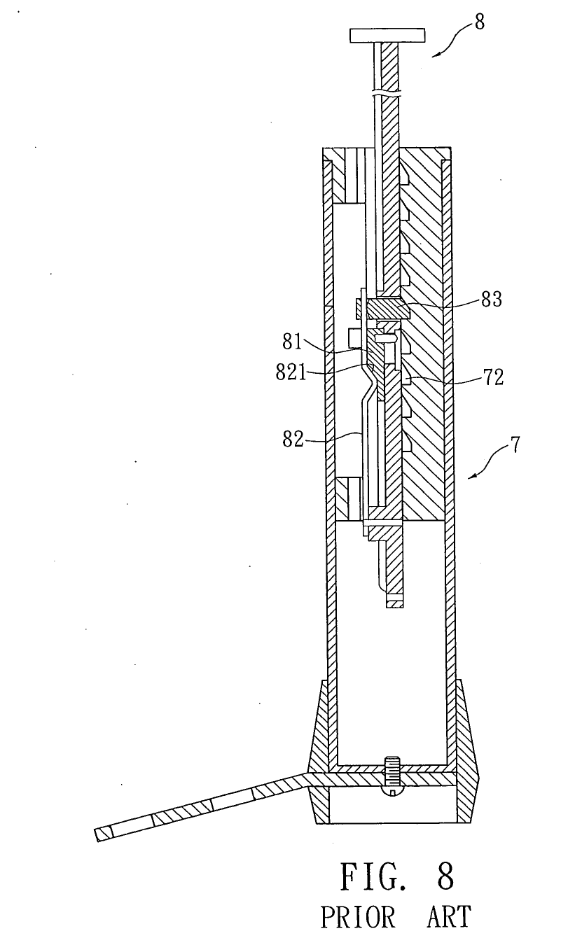

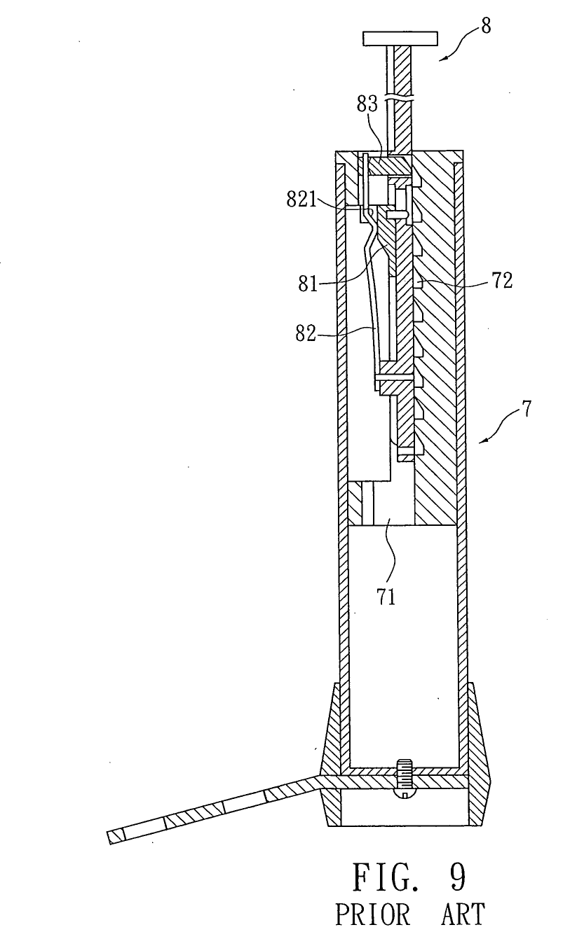

The post 352 of the driving member 35 is inlaid in the guide slot 332 of the connecting section 331 of the bar body 33. When the bar body 33 is swiveled by the resilient member 32, the post 352 will be moved along the guide slot 332 to a lowermost end thereof and the driving member 35 abuts against lower side of the slide channel 24 of the outer tube 2 as shown in FIGS. 4 and 5. When adjusting the height of the rail, the handle 36 is shifted upward to drive the driving member 35 to upward abut against the slide channel 24 of the outer tube 2. When the driving member 35 slides upward, the post 352 is moved upward within the guide slot 24. At this time, the bar body 33 is forcedly swiveled to apply a torque onto the resilient member 32. The bar body 33 is turned right and the locating member 34 is disengaged from the notch 334 of the locating section 333 as shown in FIGS. 6 and 7. Under such circumstance, the outer tube 2 can be slid up and down along the inner tube 1 to adjust the height of the rail. After adjusted, the resilient member 32 restores to its home state to again engage the locating member 34 in another notch 334 of the locating section 333. At this time, the rail is located in a new height.

The above embodiment is only used to illustrate the present invention, not intended to limit the scope thereof. Many modifications of the above embodiment can be made without departing from the spirit of the present invention.

What is claimed is:

1. A rail adjustment device comprising:
an inner tube having a fixed section at one end for fixing the inner tube on a chair, the other end of the inner tube having an insertion section;
an outer tube slidably fitted around the inner tube, one end of the outer tube being expanded to form a connecting section, a window being formed on one side of the outer tube near the connecting section;
an adjustment mechanism disposed in the inner tube and outer tube for adjustably driving the outer tube to reciprocally slide along the inner tube through a certain distance; and
a rail pad, a lower side of the rail pad being connected with the connecting section of the outer tube, an upper side of the rail pad being for a user's hand to rest thereon;
said rail adjustment device being characterized in that the adjustment mechanism includes a fixing member, a resilient member, a bar body, a locating member engageable with the bar body, a driving member, a handle fitted on the driving member for driving the bar body, wherein:
the fixing member is connected in the connecting section of the outer tube, the fixing member having a coupling section connected with a connecting section of one end of the bar body, the resilient member being fitted on the coupling section and two ends of the resilient member being respectively connected with the fixing member and the bar body;
the locating member is inserted in the insertion section of the inner tube, the locating member having an upper stop face and a lower stop face, the locating member being formed with a through hole along an axis of the bar body, whereby the bar body is fitted through the through hole; and
a guide slot is obliquely formed on outer circumference of the connecting section of the bar body, a post being disposed on inner face of the driving member, whereby the post can be inlaid in the guide slot to drive the bar body, the bar body further having a locating section adjacent to the connecting section, multiple pairs of notches being formed on opposite corners of the locating section, each notch having an upper stop face and a lower stop face, the bar body further having a stop section extending from the locating section opposite to the connecting section, the stop section being swiveled about the axis of the bar body by a certain angle.

2. The rail adjustment device as claimed in claim 1, wherein a slide channel is formed on inner wall face of the outer tube beside the window, whereby the driving member of the adjustment mechanism is slidably fitted with the slide channel.

3. The rail adjustment device as claimed in claim 2, wherein the driving member has a wing section for attaching to the slide channel of the outer tube, a tongue plate being disposed on outer face of the driving member opposite to the post, the tongue plate extending out from the window of the outer tube for fitting with the handle.

4. The rail adjustment device as claimed in claim 1, wherein the resilient member has an upper connecting end and a lower connecting end, the upper connecting end being fixed with the rail pad and the lower connecting end being fixed with the connecting section of the bar body.

5. The rail adjustment device as claimed in claim 4, wherein the resilient member is a torque spring.

6. The rail adjustment device as claimed in claim 1, wherein the upper and lower stop faces of the locating member respectively abut against the upper and lower stop faces of the notch of the bar body, whereby the locating member can be precisely engaged in the notch.
